(19) United States
(12) Patent Application Publication
(10) Pub. No.: US 2019/0213700 A1
(43) Pub. Date: Jul. 11, 2019

(54) Digital Contracting Service

(71) Applicant: Microsoft Technology Licensing, LLC, Redmond, WA (US)

(72) Inventors: Jason Katsuya ISOMURA, Bothell, WA (US); Tae Hyon CHEKAL, Renton, WA (US); Padma YADA, Sammamish, WA (US); Rudolph Alexander GIL, Redmond, WA (US); Colleen Ann FROST, Sammamish, WA (US); Tze Chee GOH, Cupertino, CA (US); Shyam Suresh DATTI, Bothell, WA (US); Sudhir Gajanan KULKARNI, Sammamish, WA (US)

(73) Assignee: Microsoft Technology Licensing, LLC, Redmond, WA (US)

(21) Appl. No.: 15/873,112

(22) Filed: Jan. 17, 2018

Related U.S. Application Data
(60) Provisional application No. 62/614,770, filed on Jan. 8, 2018.

(51) Int. Cl. G06Q 50/18; G06Q 10/10

(52) U.S. Cl. CPC G06Q 50/188; G06Q 10/10

(57) ABSTRACT

Described herein is a digital contracting system. Based upon a selected template and business context, at least one clause is retrieved. An agreement is generated based upon the retrieved at least one clause. Using stored information regarding at least one clause previously agreed to, a clause not previously agreed to is determined. Only the determined clause not previously agreed to for approval is provided to one or more parties to the agreement. Approval of the determined clause not previously agreed to is obtained.

### RELATED APPLICATION

This application claims priority to U.S. Provisional Application No. 62/614,770, filed Jan. 8, 2018, entitled “Digital Contracting Service”, the disclosure of which is hereby incorporated by reference herein in its entirety.

### BACKGROUND

The global economy has contributed to complex and sometimes confusing contractual arrangements between parties. For example, a party in a first country with a native language and legal system may be desirous to enter into a contractual relationship with another party domiciled in a second country with a different native language and legal system. When one or more of the parties is a multi-national entity with various entities, the contractual arrangements between the parties can easily become convoluted.

### SUMMARY

Described herein is a digital contracting system, comprising: a computer comprising a processor and a memory having computer-executable instructions stored thereupon which, when executed by the processor, cause the computing device to: based upon a selected template and business context, retrieve at least one clause; generate an agreement based upon the retrieved at least one clause; using stored information at least one clause previously agreed to, determine a clause not previously agreed to; provide only the determined clause not previously agreed to for approval; and obtain approval of the determined clause not previously agreed to.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a digital contracting system.

FIG. 2 is a diagram of a document assembly example,

FIG. 3 is a functional block diagram that illustrates a template creation/maintenance system.

FIG. 4 illustrates an exemplary method of generating a delta term agreement.

FIG. 5 illustrates an exemplary method of creating a template.

FIG. 6 is a functional block diagram that illustrates an exemplary computing system.

### DETAILED DESCRIPTION

Various technologies pertaining to a digital contracting service which identifies changes in contractual language in a contractual relationship between parties are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding a digital contracting service. What follows are one or more exemplary systems and methods.

Aspects of the subject disclosure pertain to the technical problem of presenting a contracting party with only changed contractual language in a contractual relationship. The technical features associated with addressing this problem involve storing information regarding clause(s) of which a particular party in a particular contractual relationship has agreed, identifying change(s) to clause(s) in the particular contractual relationship (e.g., added clause(s), change clause(s) and/or removed clause(s)), if any, and, presenting only the identified change(s) to the particular party for review, approval and signature (e.g., physical, implied, electronic, etc.). Accordingly, aspects of these technical features exhibit technical effects of more efficiently and effectively establishing and/or maintaining a contractual relationship between parties.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

An “evergreen” contract provision refers to a scenario in which a contract automatically renews periodically until one of the parties defaults and/or gives notice to terminate the contract (e.g., in compliance with the contract). Evergreen contract provisions have become increasingly common in contractual relationships between commercial parties.

Traditional commercial contracting includes presentation of clauses in the form of a pre-defined monolithic agreement document which is signed either electronically or physically by contracting parties. For example, the clause(s) contained in the agreement document can encompass a superset of clauses applicable across all potential external entities thus creating an unnecessary burden on the contracting parties to review clauses which may be superfluous within the context of the intended commerce transaction. In addition, an external entity may have already accepted contracts containing the same or similar clause(s) leading to redundant and/or conflicting terms.

Conventionally, licensing terms have been written based on a program or a channel model, which can negatively impact the parties' commerce experience. For example, a party can offer and maintain different licensing programs and channels, with hundreds of unique contract documents and many more region-specific (e.g., European Union) and/or country-specific variations. Further complicating matters is translation of these unique contract documents into native languages.

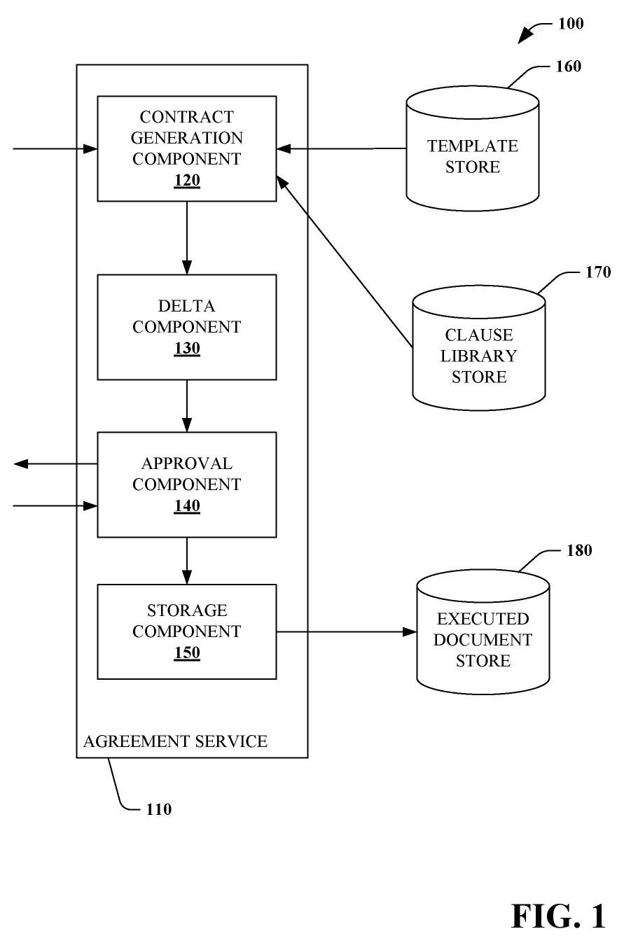

Referring to FIG. 1, a digital contracting system 100 is illustrated. The system 100 can be utilized to initiate, modify, update and/or memorialize a contractual relationship between two or more parties. In one embodiment, the system 100 can store information regarding clause(s) of which a particular party(ies) in a particular contractual relationship has agreed, identify clause(s) not previously agreed to in the particular contractual relationship (e.g., additional clause(s), changed clause(s) and/or removed clause(s)), if any, and, present only the identified clause(s) to the particular party for review, approval and signature (e.g., physical, implied, electronic, etc.). By presenting the particular party with only the identified clause(s), frustration and/or complication(s) of conventional contracting arrangements can be mitigated.

In one embodiment, the system 100 can thus facilitate detection of a minimum set of contractual clause(s) for a given commerce transaction context and dynamically build a contract for presentation; record a particular date/time when party(ies) agreed to particular clause(s); employ a clause acceptance history to determine clause(s) that have already been accepted and present only clause(s) not previously agreed to (e.g., “delta”); and/or allow a party to selectively make clause updates which are provided (e.g., pushed) to contracting parties for acceptance. In one embodiment, the system 100 can further employ business rule constraint(s) in conjunction with a history of clause(s) that have been signed by a particular contracting entity to ensure the particular contracting entity is only signing those clause(s) which are relevant for a given business context.

The system 100 includes an agreement service 110 having a contract generation component 120, a delta component 130, an approval component 140 and a storage component 150. In response to a request to generate an agreement, the contract generation component 120 utilizes a template stored in a template store 160 to generate the agreement (e.g., contract).

In one embodiment, the request can be received from a user associated with a licensor entity. For example, the request can be generated by the user associated with the licensor entity in response to a request to purchase a particular product received from a user associated with a licensee entity.

In one embodiment, the request can be received from a user associated with the licensee entity. For example, the request can be generated in response to a request to license a particular product from the user associated with the licensee entity.

The contract generation component 120 can retrieve a particular template from the template store 160 (e.g., selectively). In one embodiment, the particular template can be retrieved from the template store 160 based upon template selection information received from a user (e.g., associated with licensor entity and/or licensee entity). For example, a user can select one of a plurality of templates stored in the template store 160 and/or the user can implicitly and/or explicitly provide information (e.g., business context information) which the contract generation component 120 can utilize to identify a particular template to be utilized for generation of the agreement.

A template is an object which references one or more clauses stored in a clause library store 170. A template defines which clause(s) and/or combination and sequencing of clauses the contract generation component 120 will utilize to assemble the agreement for a given business context (e.g., business rule(s)). In one embodiment, templates are JavaScript Object Notation (JSON) objects.

A clause comprises text of the clause and associated metadata (e.g., name, version, effective data, etc.). In one embodiment, the metadata comprises business rule characteristic(s) (e.g., attribute(s)) associated with the clause (e.g., constraint(s)). For example, a particular clause may only be valid for commerce transaction(s) between entities located in the United States. The metadata associated with the particular clause can identify that the clause is only applicable to entities located in the United States.

In one embodiment, clauses are atomic such that each clause is written so that the clause can stand on its own from a legal and/or presentment perspective. When a clause is updated, template(s), if any, which reference the clause are also impliedly updated. Clauses are further natively localizable, that is, a particular clause can be related to a particular geographic area (e.g., country, region, etc.) Example clauses include those related to: affiliate rights, limited warranty and/or applicable law. Clauses can be reference by zero, one or a plurality of templates. In one embodiment, clauses are JSON objects which reference documents storing text as blobs. In one embodiment, template(s) can include header information including, for example, an effective date and a signature method (e.g., click to accept, electronic signature, physical signature, etc.).

Once the particular template has been retrieved, the contract generation component 120 can determine a business context associated with generation of the agreement. In one embodiment, the business context can be determined explicitly, for example, based upon information (e.g., geographical location) provided by a user associated with the licensee entity and/or a user associated with the licensor entity. In one embodiment, the business context can be determined implicitly, for example, based upon a geographical location associated an Internet Protocol (IP) address associated with device associated with the licensee entity and/or a device associated with the licensor entity.

Based upon the determined business context, the contract generation component 120 can use the template to generate the agreement. The template can provide one or more clauses, combination of clauses and/or sequencing of potential clauses for an agreement based upon the determined business context.

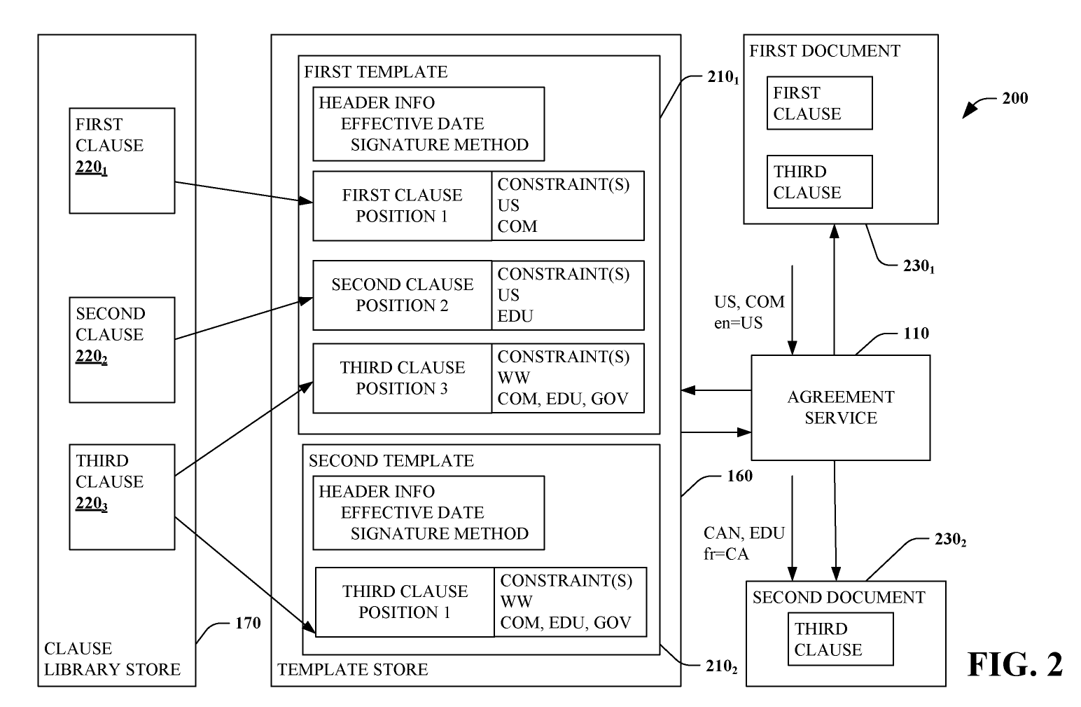

Referring briefly to FIG. 2, a document assembly example 200 is illustrated. The example 200 includes the agreement service 110 utilizing a first template 210₁ and a second template 210₂ stored in the template store 160. The templates 210 employ three clauses 220₁, 220₂, 220₃ stored in the clause library store 170.

In the example 200, the agreement service 110 is utilized to generate a first document 230₁ and a second document 230₂. As part of the agreement generation process for the first document 230₁, business constraints “US, COM, en=US” are provided (e.g., input) to the agreement service 110. The first template 210₁ which references clauses 220₁, 220₂, 220₃ is utilized to generate the first document 230₁. Additionally, the first template 210₁ includes sequencing information (e.g., “Position 1”, “Position 2”, “Position 3”) for ordering of the clauses 220₁, 220₂, 2203. Each of the clauses 220₁, 220₂, 220₃ includes constraints for which the particular clause is applicable “US, COM” “US, EDU”, “WW, COM, EDU, GOV”. Based upon information stored in the first template 210₁, and the input business constraints, the agreement service 110 generates the first document 230₁. Because the second clause 220₂ applies to “EDU” and the input business constraint specifies “COM”, the second clause 220₂ is not included in the first document 230₁.

Similarly, the agreement service 110 generates the second document 230₂. In this scenario, the input business constraints specific “CAN, EDU, fr=CA”. Based upon the second template 210₂ (which only references the third clause 220₃) and the input business constraints, the second document 230₁ includes only the third clause 220₃.

Turning back to FIG. 1, next, based on the generated agreement, the delta component 130 can determine change(s) to clause(s), if any, in the particular contractual relationship. The delta component 130 can review a contracting history of the parties to the particular contractual relationship based upon agreement(s) stored in an executed document store 180.

The executed document store 180 can store information regarding agreement(s) signed by particular contracting parties. The information can include, for example, identifying information of the contracting parties (e.g., name(s), corporate hierarchical information, etc.), agreed upon clause(s) (e.g., name, version information, etc.) and/or temporal information (e.g., date and/or time of signing). In one embodiment, “signing” includes an implicit and/or explicit acceptance.

In one embodiment, using information retrieved from the executed document store 180, the delta component 130 can determine that the parties to the particular contractual relationship have previously agreed to one or more clauses of the generated agreement. The delta component 130 thus comprises logic to identify and filter clause(s) previously accepted by a particular entity. Based upon this determination, the delta component 130 can filter the previously agreed to clause(s) from the generated agreement when providing information to the approval component 140.

In one embodiment, using information retrieved from the executed document store 180, the delta component 130 can determine that the parties to the particular contractual relationship have not previously agreed to one or more clauses (e.g., clause itself and/or current version of a particular clause). Based upon this determination, the delta component 130 can maintain the not previously agreed to one or more clause in the generated agreement when providing information to the approval component 140.

By presenting the particular party with only the identified changes, frustration and/or complication(s) of conventional contracting arrangements can be mitigated. The delta component 130 can thus facilitate identification of a minimum set of contractual clause(s) for a given business context and dynamically build a contract for presentation.

Based upon information received from the delta component 130, the approval component 140 can provide clause(s) in the generated agreement not previously agreed to by the contracting party(ies) to the contracting party(ies) for approval (e.g., acceptance). In response, the contracting party(ies) can provide an indication of approval. In one embodiment, the indication of approval is implicit (e.g., “click to accept”). In one embodiment, the indication of approval is explicit (e.g., electronic signature). In one embodiment, the indication of approval is receipt of a scanned written signature.

The approval component 140 can record a particular date and/or time when party(ies) agreed to particular clause(s) of a particular agreement in the executed document store 180. In one embodiment, a unique document object (e.g., JSON object) is created with reference to an immutable and unchangeable text document blob, both of which are stored in the executed document store 180. The document object contains the object identifier for the template which was used to generate the agreement, along with an object identifier for each clause referenced within the template (e.g., generated agreement). Once the contracting entity accepts the clause(s), acceptance is recorded at the clause level within a document object stored in the executed document store 180.

As discussed previously, information stored in the executed document store 180 can subsequently be employed by the system 100 to facilitate a clause acceptance history to determine clause(s) that have already been accepted and present only changed (e.g., “delta”) clause(s) and/or allow a party to selectively make clause updates which are provided (e.g., pushed) to contracting parties for acceptance. The executed document store 180 can thus provide a record of clause acceptance at an atomic level by a particular contracting entity.

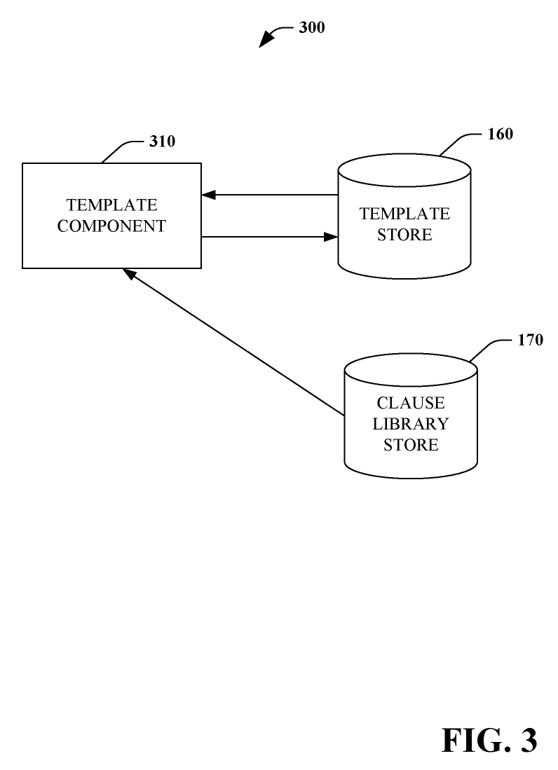

Turning to FIG. 3, a template creation/maintenance system 300 is illustrated. The system 300 includes a template component 310, the template store 160 and the clause library store 170. The system 300 can be utilized to create template(s) which are stored in the template store 160 for use by the system 100, as discussed above.

With the template component 310 a user can define a template for use in generating an agreement. The user can provide business rule(s) and/or clause(s) to be used by the system 100 in generating the agreement. For example, the user can identify that particular clause(s) are to be utilized for a particular geographical location, for a particular product, for a particular user, for a particular type of user (e.g., retail, wholesale, etc.) and the like.

In one embodiment, the user can identify business constraint(s) for which particular clause(s) apply or are excluded from. For example, for the sale of a particular product in a first country, a first clause is to be utilized; however, for the sale of the particular product in a second country, a second clause is to be utilized. In one embodiment, the user can identify clause(s) that are to be utilized for all agreement related to a particular product.

The template component 310 can further facilitate combination of clauses, for example, include a third clause when a first clause is included. The template component 310 can also facilitate sequencing of clauses (e.g., ordering) of clauses within a generated agreement.

In one embodiment, the template component 310 can further identify information (e.g., parameter(s)) to be selected prior to generation of the agreement which is stored in the template. For example, the template component 310 can receive information requiring identification of a U.S. sale or non-U.S. sale, identification of a particular product, identification of a particular contracting party, etc. This information can then be requested and/or used by the contract generation component 120 during generation of the agreement (e.g., to selected appropriate clause(s) to include in the agreement).

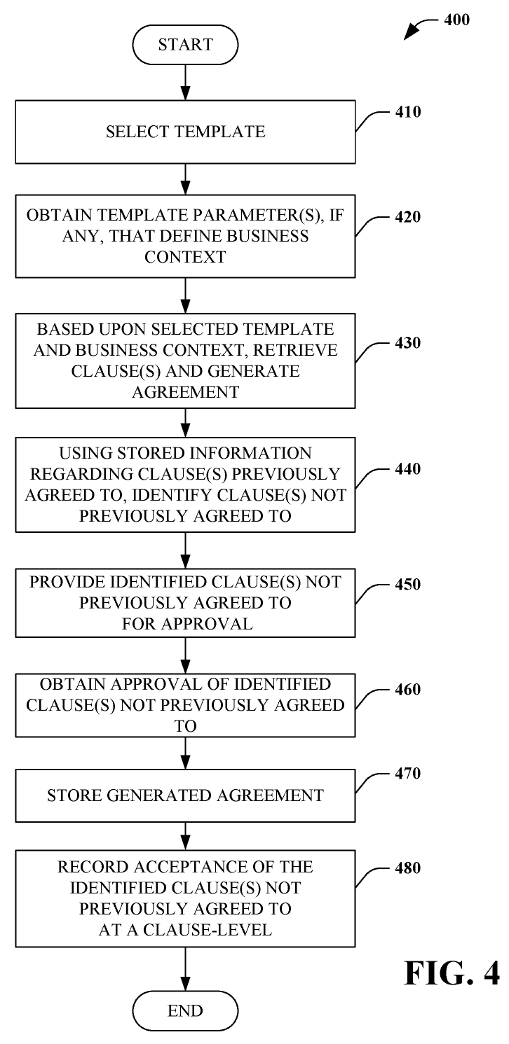

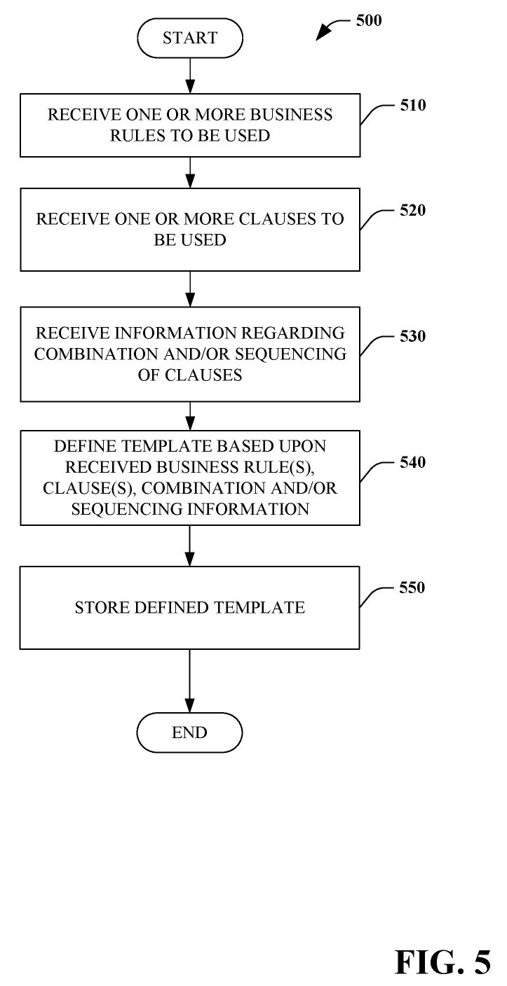

FIGS. 4 and 5 illustrate exemplary methodologies relating to a digital contracting service. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 4, a method of generating a delta term agreement 400 is illustrated. In one embodiment, the method 400 is performed by the system 100. At 410, a template is selected. For example, a user can select one of a plurality of templates stored on in a template store 160 to be used to generate an agreement.

At 420, template parameter(s), if any, that define a business context are obtained. For example, the selected template can require a user to identify business constraint(s) which define a business context of the agreement to be generated.

At 430, based upon the selected template and business context, clause(s) are retrieved and an agreement generated. For example, the clause(s) can be retrieved from a clause library store 170.

At 440, using stored information regarding clause(s) previously agreed to, clause(s) not previously agreed to are identified. At 450, the identified clause(s) not previously agreed to are provided for approval.

At 460, approval of the identified clause(s) not previously agreed to is obtained. At 470, the generated agreement is stored. At 480, acceptance of the identified clause(s) not previously agreed to is recorded at the clause-level. In one embodiment, after receipt of the approval (e.g., in response to receipt of the approval), a software product licensed and/or sold by the generated agreement can be electronically delivered.

Turning to FIG. 5, a method of creating a template 500 is illustrated. At 510, one or more business rules to be used in generating an agreement is received. At 520, one or more clauses to be used in generating the agreement is received. At 530, information regarding a combination and/or sequencing of clauses is received. At 540, the template is defined based upon the received business rule(s), clause(s), combination and/or sequencing information. At 550, the defined template is stored.

Described herein is a digital contracting system, comprising: a computer comprising a processor and a memory having computer-executable instructions stored thereupon which, when executed by the processor, cause the computing device to: based upon a selected template and business context, retrieve at least one clause; generate an agreement based upon the retrieved at least one clause; using stored information regarding at least one clause previously agreed to, determine a clause not previously agreed to; provide only the determined clause not previously agreed to for approval; and obtain approval of the determined clause not previously agreed to. The system can include the memory having further computer-executable instructions stored thereupon which, when executed by the processor, cause the computing device to: after receipt of the approval, store the generated agreement.

The system can further include the memory having further computer-executable instructions stored thereupon which, when executed by the processor, cause the computing device to: after receipt of the approval, record acceptance of the determined clause not previously agreed to. The system can include wherein the record of acceptance of the determined clause not previously agreed to is performed at a clause-level. The system can further include wherein the at least one clause is an atomic unit.

The system can include wherein the selected template comprises a business rule to be applied when determine which of a plurality of clauses are to be included in the generated agreement. The system can further include wherein the selected template comprises information regarding at least one of combination or sequencing of a plurality of clauses potentially to be included in the generated agreement. The system can include wherein the business context is determined implicitly based upon a device associated with at least one party to the agreement to be generated.

The system can further include wherein the business context is determined based upon information received from at least one party to the agreement to be generated. The system can include wherein obtain approval of the determined clause not previously agreed to comprises receiving at least one of a click to accept response or an electronic signature. The system can further include the memory having further computer-executable instructions stored thereupon which, when executed by the processor, cause the computing device to: after receipt of the approval, electronically deliver a software product licensed by the generated agreement.

Described herein is a method of generating a delta term agreement, comprising: based upon a selected template and business context, retrieving at least one clause; generating an agreement based upon the retrieved at least one clause; using stored information regarding at least one clause previously agreed to, determining a clause not previously agreed to; providing only the determined clause not previously agreed to for approval; obtaining approval of the determined clause not previously agreed to; and in response to receipt of the approval, electronically delivering a software product licensed by the generated agreement. The method can include after receipt of the approval, recording acceptance of the determined clause not previously agreed to.

The method can further include wherein recording acceptance of the determined clause not previously agreed to is performed at a clause-level. The method can include wherein the at least one clause is an atomic unit. The method can further include wherein the selected template comprises a business rule to be applied when determining which of a plurality of clauses are to be included in the generated agreement.

Described herein is a computer storage media storing computer-readable instructions that when executed cause a computing device to: based upon a selected template and business context, retrieve at least one clause; generate an agreement based upon the retrieved at least one clause; using stored information regarding at least one clause previously agreed to, determine a clause not previously agreed to; provide only the determined clause not previously agreed to for approval; and obtain approval of the determined clause not previously agreed to. The computer storage media can include wherein the selected template comprises information regarding at least one of combination or sequencing of a plurality of clauses potentially to be included in the generated agreement.

The computer storage media can further include wherein the business context is determined at least one of implicitly based upon a device associated with at least one party to the agreement to be generated or based upon information received from at least one party to the agreement to be generated. The computer storage media can store further computer-readable instructions that when executed cause a computing device to: after receipt of the approval, electronically deliver a software product licensed by the generated agreement.

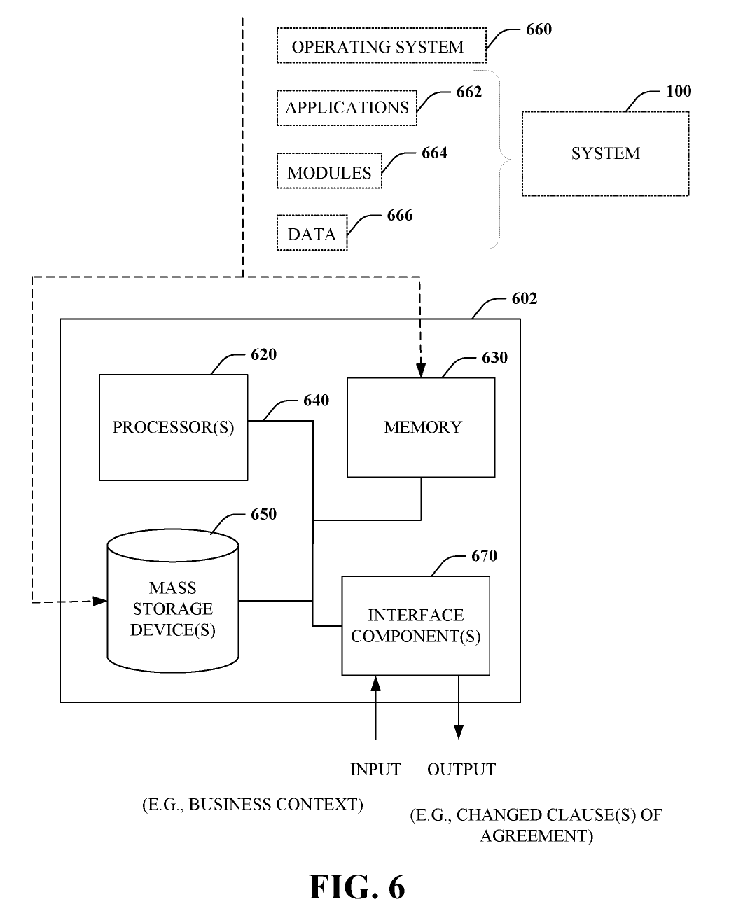

With reference to FIG. 6, illustrated is an example general-purpose computer or computing device 602 (e.g., mobile phone, desktop, laptop, tablet, watch, server, hand-held, programmable consumer or industrial electronics, set-top box, game system, compute node, etc.). For instance, the computing device 602 may be used in a digital contracting system 100.

The computer 602 includes one or more processor(s) 620, memory 630, system bus 640, mass storage device(s) 650, and one or more interface components 670. The system bus 640 communicatively couples at least the above system constituents. However, it is to be appreciated that in its simplest form the computer 602 can include one or more processors 620 coupled to memory 630 that execute various computer executable actions, instructions, and or components stored in memory 630. The instructions may be, for instance, instructions for implementing functionality described as being carried out by one or more components discussed above or instructions for implementing one or more of the methods described above.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 620 can be a graphics processor.

The computer 602 can include or otherwise interact with a variety of computer-readable media to facilitate control of the computer 602 to implement one or more aspects of the claimed subject matter. The computer-readable media can be any available media that can be accessed by the computer 602 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 602. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 630 and mass storage device(s) 650 are examples of computer-readable storage media. Depending on the exact configuration and type of computing device, memory 630 may be volatile (e.g., RAM), non-volatile (e.g., ROM, flash memory, etc.) or some combination of the two. By way of example, the basic input/output system (BIOS), including basic routines to transfer information between elements within the computer 602, such as during start-up, can be stored in nonvolatile memory, while volatile memory can act as external cache memory to facilitate processing by the processor(s) 620, among other things.

Mass storage device(s) 650 includes removable/non-removable, volatile/non-volatile computer storage media for storage of large amounts of data relative to the memory 630. For example, mass storage device(s) 650 includes, but is not limited to, one or more devices such as a magnetic or optical disk drive, floppy disk drive, flash memory, solid-state drive, or memory stick.

Memory 630 and mass storage device(s) 650 can include, or have stored therein, operating system 660, one or more applications 662, one or more program modules 664, and data 666. The operating system 660 acts to control and allocate resources of the computer 602. Applications 662 include one or both of system and application software and can exploit management of resources by the operating system 660 through program modules 664 and data 666 stored in memory 630 and/or mass storage device (s) 650 to perform one or more actions. Accordingly, applications 662 can turn a general-purpose computer 602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 662, and include one or more modules 664 and data 666 stored in memory and/or mass storage device(s) 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 602 also includes one or more interface components 670 that are communicatively coupled to the system bus 640 and facilitate interaction with the computer 602. By way of example, the interface component 670 can be a port (e.g., serial, parallel, PCMCIA, USB, FireWire, etc.) or an interface card (e.g., sound, video, etc.) or the like. In one example implementation, the interface component 670 can be embodied as a user input/output interface to enable a user to enter commands and information into the computer 602, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 670 can be embodied as an output peripheral interface to supply output to displays (e.g., LCD, LED, plasma, etc.), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A digital contracting system, comprising:
a computer comprising a processor and a memory having computer-executable instructions stored thereupon which, when executed by the processor, cause the computing device to:
based upon a selected template and business context, retrieve at least one clause;
generate an agreement based upon the retrieved at least one clause;
using stored information regarding at least one clause previously agreed to, determine a clause not previously agreed to;
provide only the determined clause not previously agreed to for approval; and
obtain approval of the determined clause not previously agreed to.

2. The system of claim 1, the memory having further computer-executable instructions stored thereupon which, when executed by the processor, cause the computing device to:
after receipt of the approval, store the generated agreement.

3. The system of claim 1, the memory having further computer-executable instructions stored thereupon which, when executed by the processor, cause the computing device to:
after receipt of the approval, record acceptance of the determined clause not previously agreed to.

4. The system of claim 3, wherein the record of acceptance of the determined clause not previously agreed to is performed at a clause-level.

5. The system of claim 1, wherein the at least one clause is an atomic unit.

6. The system of claim 1, wherein the selected template comprises a business rule to be applied when determine which of a plurality of clauses are to be included in the generated agreement.

7. The system of claim 1, wherein the selected template comprises information regarding at least one of combination or sequencing of a plurality of clauses potentially to be included in the generated agreement.

8. The system of claim 1, wherein the business context is determined implicitly based upon a device associated with at least one party to the agreement to be generated.

9. The system of claim 1, wherein the business context is determined based upon information received from at least one party to the agreement to be generated.

10. The system of claim 1, wherein obtain approval of the determined clause not previously agreed to comprises receiving at least one of a click to accept response or an electronic signature.

11. The system of claim 1, the memory having further computer-executable instructions stored thereupon which, when executed by the processor, cause the computing device to:
after receipt of the approval, electronically deliver a software product licensed by the generated agreement.

12. A method of generating a delta term agreement, comprising:
based upon a selected template and business context, retrieving at least one clause;
generating an agreement based upon the retrieved at least one clause;
using stored information regarding at least one clause previously agreed to, determining a clause not previously agreed to;
providing only the determined clause not previously agreed to for approval;
obtaining approval of the determined clause not previously agreed to; and
in response to receipt of the approval, electronically delivering a software product licensed by the generated agreement.

13. The method of claim 12, further comprising:
after receipt of the approval, recording acceptance of the determined clause not previously agreed to.

14. The method of claim 13, wherein recording acceptance of the determined clause not previously agreed to is performed at a clause-level.

15. The method of claim 12, wherein the at least one clause is an atomic unit.

16. The method of claim 15, wherein the selected template comprises a business rule to be applied when determining which of a plurality of clauses are to be included in the generated agreement.

17. A computer storage media storing computer-readable instructions that when executed cause a computing device to:
based upon a selected template and business context, retrieve at least one clause;
generate an agreement based upon the retrieved at least one clause;
using stored information regarding at least one clause previously agreed to, determine a clause not previously agreed to;
provide only the determined clause not previously agreed to for approval; and
obtain approval of the determined clause not previously agreed to.

18. The computer storage media of claim 17, wherein the selected template comprises information regarding at least one of combination or sequencing of a plurality of clauses potentially to be included in the generated agreement.

19. The computer storage media of claim 17, wherein the business context is determined at least one of implicitly based upon a device associated with at least one party to the agreement to be generated or based upon information received from at least one party to the agreement to be generated.

20. The computer storage media of claim 17, storing further computer-readable instructions that when executed cause a computing device to:
after receipt of the approval, electronically deliver a software product licensed by the generated agreement.
